(19) United States
(12) Patent Application Publication
(10) Pub. No.: US 2015/0070754 A1
(43) Pub. Date: Mar. 12, 2015

(54) INFRARED OPTICAL SYSTEM

(71) Applicant: TAMRON CO., LTD., Saitama-shi, Saitama (JP)

(72) Inventor: Shoko Kawai, Saitama-shi, Saitama (JP)

(73) Assignee: TAMRON CO., LTD., Saitama-shi, Saitama (JP)

(21) Appl. No.: 14/386,501

(22) PCT Filed: Mar. 21, 2013
(86) PCT No.: PCT/JP2013/058021

§ 371 Date: Sep. 19, 2014

(30) Foreign Application Priority Data
Mar. 21, 2012 (JP) 2012-063934

(51) Int. Cl. G02B 9/10; G02B 13/14

(52) U.S. Cl. CPC G02B 9/10; G02B 13/14
USPC 359/356

(57) ABSTRACT

An infrared optical system of two-lens structure comprises a front or first lens of negative refractive power and a rear or second lens of positive refractive power disposed in series relative to an object, the first lens having its concave surface faced toward the imaging plane, the second lens having its convex surface faced toward the object, the infrared optical system meeting the requirements as defined in the following formula 2.1≦d/f≦11, where d is an axial distance from the surface of the first lens closer to the imaging plane to the surface of the second lens closer to the object, and f is a focal length of the entire optical system.

### BACKGROUND ART

The present invention relates to infrared optical systems, and more particularly, wide viewing angle infrared optical systems suitable for infrared-ray imaging devices such as infrared cameras. Hereinafter, the term ‘infrared or infrared rays’ means radiations of mid-infrared rays of wavelength ranging from 3 μm to 5 μm and far-infrared rays of wavelength ranging from 8 μm to 14 μm.

It has been strongly desired in the prior art that infrared optical systems could be produced to have component lens pieces as small as possible in number since infrared-ray lens materials available for them, such as germanium (Ge), chalcogenide, and the like, are very expensive.

(1) One typical two-lens infrared optical system suggested in the prior art is of two-lens structure where a front or first lens L1 closer to an object and a rear or second lens L2 farther from the object are arranged, both of them being made of zinc sulfide (ZnS). The first lens L1 is a positive meniscus lens, having its convex surface faced toward the object and its concave surface shaped in aspherical surface useful in achieving diffraction, while the second lens L2 has at least one of its surfaces shaped in aspherical surface (e.g., see Patent Document 1).

(2) Another typical two-lens infrared optical system suggested in the prior art is the one effective on incident beam ranging from infrared rays to far-infrared rays in a specific wavelength range from 3 μm to 14 μm, which is of two-lens structure where arranged are a front or first lens closer to an object and shaped in convex meniscus lens having its convex surface faced toward the object and a rear or second lens farther from the object and shaped in convex meniscus lens having its concave surface faced toward the object, and at least one of the first and second lenses has its both sides formed in diffraction optics surfaces (e.g., see Patent Document 2).

(3) Still another typical two-lens infrared optical system suggested in the prior art is the one including a front or first lens G1 closer to an object and a rear or second lens G2 farther from the object where the first lens G1 is shaped in positive meniscus lens having its convex surface faced toward the object while the second lens G2 is shaped in positive meniscus lens having its convex surface faced toward an imaging plane, and the rearmost surface of the first lens G1 closer to the imaging plane or the foremost surface of the second lens G2 closer to the object is formed in diffraction optics surface while one or more of the remaining surfaces other than the diffraction optics surface are aspherical (e.g., see Patent Document 3).

(4) On the other hand, it is desirable that infrared optical systems used in dark-field surveillance devices are designed to have a wider static monitoring range, and to that end, wider viewing angle infrared optical systems have been developed. For instance, a typical example of such infrared optical systems is directed to achieve a bright infrared optical system including a reduced number of component lens pieces, keeping a greater back focus, and successfully compensating for various types of aberration including distortion where a front or first lens group G1 closer to an object and of negative refractive power and a rear or second lens group G2 farther from the object and of positive refractive power are arranged in series, the first lens group G1 including at least one negative meniscus lens piece L11 that has its convex surface faced toward the object, and the infrared optical system meets predetermined conditions as defined in mathematical expressions (see Patent Document 4).

### LIST OF THE DOCUMENTS OF THE RELATED ART

Patent Document 1

JP Preliminary Publication of Unexamined Pat. Appl. No. 2003-295052

Patent Document 2

JP Preliminary Publication of Unexamined Pat. Appl. No. 2010-113191

Patent Document 3

JP Preliminary Publication of Unexamined Pat. Appl. No. 2011-128538

Patent Document 4

JP Preliminary Publication of Unexamined Pat. Appl. No. 2002-196233

(1) The infrared optical system disclosed in Patent Document 1 is of two-lens structure, keeping angle of field as wide as 18°. As to the lens arrangement, a positive lens closer to an object and a reduced refractive power positive or negative lens father from the object are disposed in series, which unavoidably leads to a greater Petzval sum and thus to a difficulty in keeping the imaging plane flat as the angle of field becomes wider. Additionally, as recognized in Patent Document 1, the infrared optical system of two-lens structure, with the angle of field wider than 20°, comes to encounter a difficulty in compensating for abaxial aberration, and to cope with it, it is taught that the infrared optical system should be of three-lens structure.

(2) The infrared optical system disclosed in Patent Document 2 is of two-lens structure, keeping angle of field as wide as 28°. As to the lens arrangement, however, a positive lens and another positive lens are disposed serially relative to an object, which unavoidably leads to a greater Petzval sum and thus to a difficulty in keeping the imaging plane flat as the angle of field becomes wider.

(3) The infrared optical system disclosed in Patent Document 3 is of two-lens structure, keeping angle of field as wide as 34°, where a positive lens and another positive lens are disposed serially relative to an object, which unavoidably leads to a greater Petzval sum and thus to a difficulty in keeping the imaging plane flat as the angle of field becomes wider.

(4) The infrared optical system disclosed in Patent Document 4 is of a type that a lens of negative refractive power is at the head of the succeeding one(s), keeping field of angle as wide as 66°. As to the number of the component lens pieces, 4 or 5 of them are required, which results in disadvantages of increased manufacturing cost, and greater loss of light due to light transmission through and surface reflection from the lens pieces.

### BRIEF SUMMARY OF THE INVENTION

The present invention is made to overcome the aforementioned problems in the prior art infrared optical systems, and accordingly, it is an object of the present invention to provide an infrared optical system that is, although of two-lens structure, capable of successfully compensating for a variety of aberrations even with a wide angle of view. Especially, an object of the invention is to provide an infrared optical system that, during zooming out for a wide angle range from 40° to 110°, can avoid an increase in the Petzval sum and ensure a flat imaging plane.

The present invention provides an infrared optical system of two-lens structure, comprising a front or first lens of negative refractive power and a rear or second lens of positive refractive power disposed in series relative to an object,

the first lens having its concave surface faced toward the imaging plane, and

the second lens having its convex surface faced toward the object.

The infrared optical system meets the requirements as defined in the following formula (1):

2.1≦d/f≦11 (1)

where d is an axial distance from the surface of the first lens closer to the imaging plane to the surface of the second lens closer to the object, and f is a focal length of the entire optical system.

With regard to the formula (1), the requirements may be refined as follows:

2.9≦d/f≦5.5 (1′)

In accordance with the present invention, the infrared optical system is, although of two-lens structure, capable of successfully compensating for a variety of aberrations even with a wide angle of view. Especially, achieved is the infrared optical system that, during zooming out for a wide angle range from 40° to 110°, can avoid an increase in the Petzval sum and ensure a flat imaging plane. Specifically, the infrared optical system according to the present invention can reduce the Petzval sum down to one third of that of the infrared optical system in the cited Patent Document 2 or even smaller.

When the value of d/f is smaller than the lower limit as defined in the formula (1), the Petzval sum becomes greater, which leads to difficulties in keeping the imaging plane flat and widening the angle of field. When the value of d/f exceeds the upper limit as defined in the formula (1), the optical system encounters a difficulty in suppressing chromatic aberration of magnification. In addition, an extent of astigmatism becomes greater in both sides of the lenses, and the optical performance is highly sensitive to a manufacturing tolerance, therefore, making the manufacturing complicated.

With an arrangement satisfying the conditions expressed in the formula (1′), the resultant infrared optical system can successfully compensate for the aberrations even with a wide angle of field. Especially, during zooming out for a wide angle range from 40° to 110°, such an infrared optical system is effective to suppress the Petzval sum to the minimal and ensure an ideal flat imaging plane.

Various embodiments and effects of the present invention will be described below.

### EMBODIMENT 1

In the infrared optical system according to the present invention, an aperture stop is disposed between the first and second lenses.

Disposing the aperture stop between the first lens of negative refractive power and the second lens of positive refractive power permits the first and second lenses to transmit abaxial rays at their respective lower positions, and since this is effective in suppressing various types of aberration, such as astigmatism, of abaxial rays in both sides of the first and second lenses, the lenses thus reduced in number work well to compensate for astigmatism.

Furthermore, with the first lens of negative refractive power being disposed closer to the object than the aperture stop, the optical system can have its entrance pupil positioned closer to the object than the aperture stop and reduced in diameter, thereby considerably overcoming a deficiency of peripheral light that has been a critical problem in the infrared optical system manufacturing.

Meanwhile, disposing the aperture stop between the first and second lenses facilitates a reduction in diameter for both the first and second lenses.

### EMBODIMENT 2

In another aspect of the present invention, the infrared optical system meets the requirements as defined in the following formula (2):

−2.1≦f1/f2≦−0.80 (2)

where f1 is a focal length of the first lens, and f2 is a focal length of the second lens.

When the value of f1/f2 is smaller than the lower limit as defined in the formula (2), the Petzval sum becomes greater, which leads to failures in keeping the imaging plane flat and widening the angle of field.

When the value of f1/f2 exceeds the upper limit as defined in the formula (2), the Petzval sum becomes greater in the negative direction. In addition, when that value exceeds the upper limit as in the formula (2), greater spherical aberrations and comatic aberration are developed in both sides of the first and second lenses, leading to a difficulty in suppressing the aberrations.

With regard to the formula (2), the requirements may be refined as follows:

−1.6≦f1/f2≦−0.96 (2′)

With an arrangement satisfying the conditions expressed in the formula (2′), the resultant infrared optical system is effective to suppress the Petzval sum to the minimal and keep the imaging plane flat, thereby enabling a wider angle of view. In addition, such an infrared optical system successfully suppresses spherical aberration and comatic aberration in both sides of the first and second lenses, thereby facilitating compensation for the aberrations.

### EMBODIMENT 3

In still another aspect of the present invention, the infrared optical system has the first and second lenses made of germanium.

Since germanium that is a glass material of high refractive index and superior chromatic dispersibility is used for all the lenses, the resultant infrared optical system can effectively suppress spherical aberration and chromatic aberration, compared with the ones made of some other glass materials such as chalcogenide.

### EMBODIMENT 4

In further another aspect of the present invention, the infrared optical system meets the requirements as defined in the following formula (3):

0.8≦r2/f≦60 (3)

where r2 is a radius of curvature in the surface of the first lens closer to the imaging plane, and f is a focal length of the entire optical system.

When the value of r2/f is smaller than the lower limit as defined in the formula (3) or when it exceeds the upper limit as defined in the same, greater spherical aberrations, comatic aberration, and astigmatism are developed in both sides of the first and second lenses, leading to a difficulty in compensating for spherical aberration, comatic aberration, and astigmatism throughout the infrared optical system.

With regard to the formula (3), the requirements may be refined as follows:

3.1≦r2/f≦7.1 (3′)

With an arrangement satisfying the conditions expressed in the formula (3′), the resultant infrared optical system is effective to suppress spherical aberration and comatic aberration in both sides of the first and second lenses, thereby facilitating compensation for the aberrations.

### BRIEF DESCRIPTION OF THE SEVERAL VIEWS OF THE DRAWING

FIG. 1 is a vertical sectional view illustrating optics of a first embodiment of an infrared optical system according to the present invention;

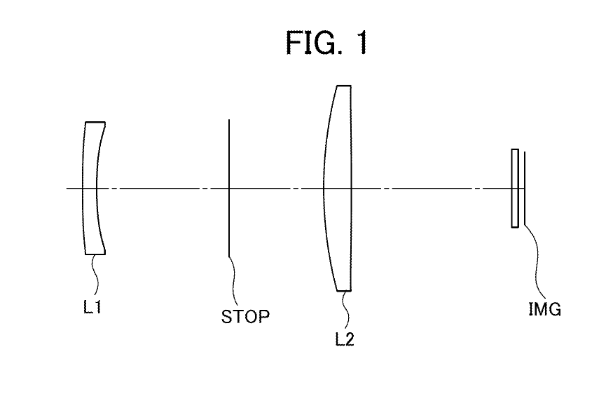

FIG. 2 depicts graphs of various aberrations developed in the first embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

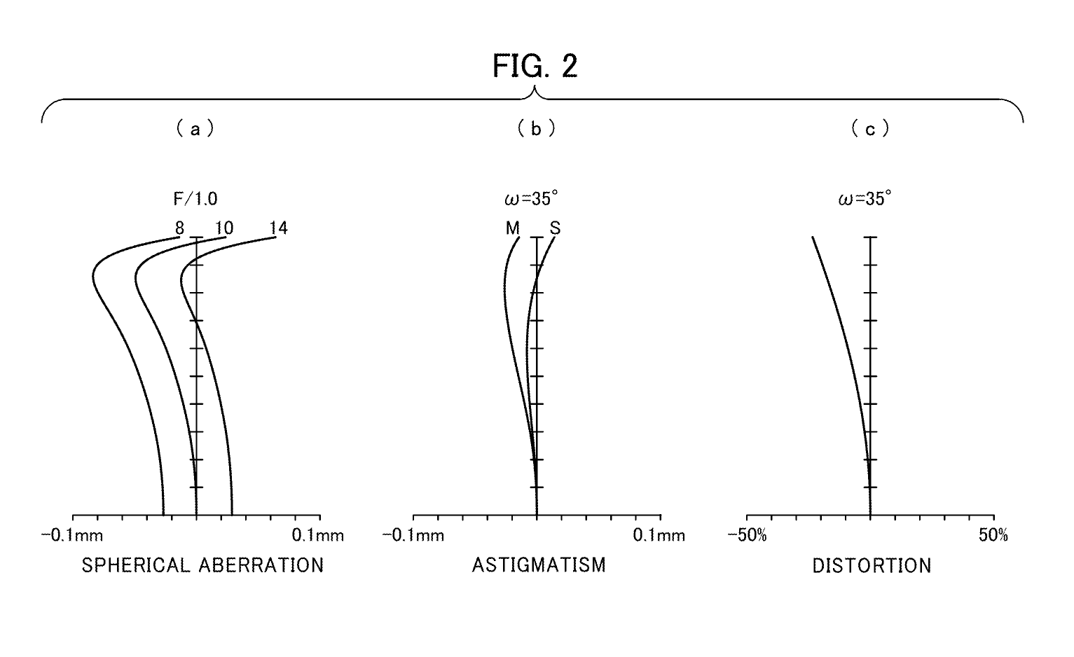

FIG. 3 is a vertical sectional view illustrating optics of a second embodiment of the infrared optical system according to the present invention;

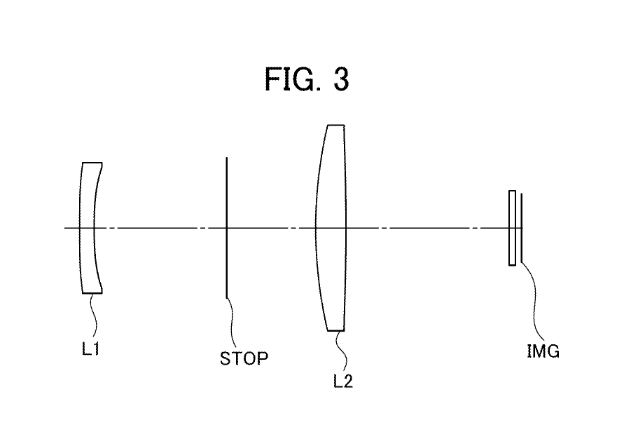

FIG. 4 depicts graphs of various aberrations developed in the second embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

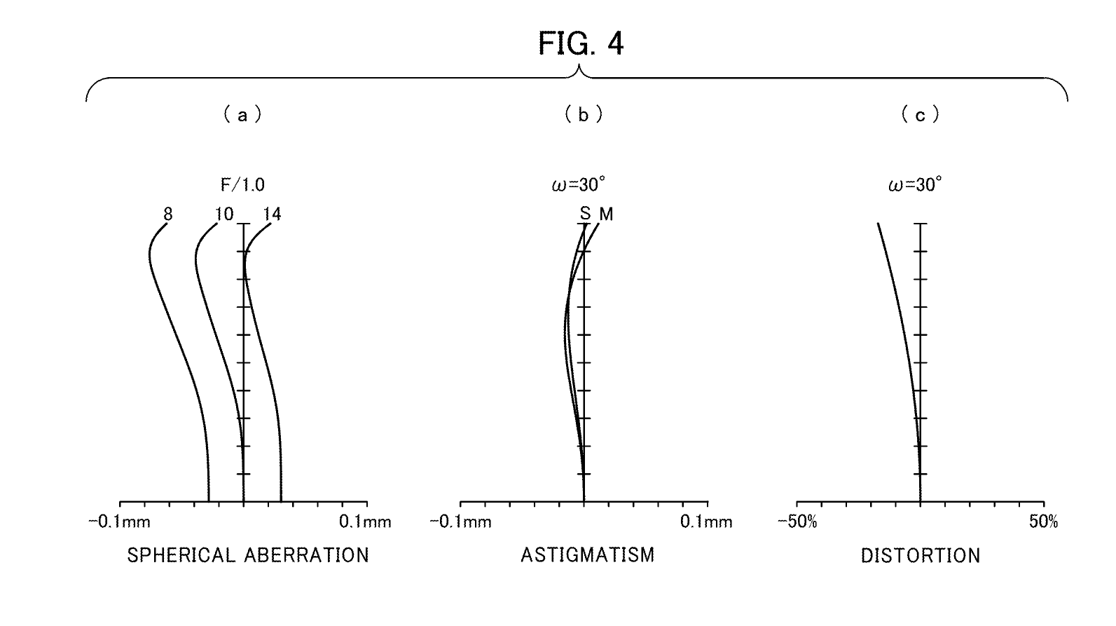

FIG. 5 is a vertical sectional view illustrating optics of a third embodiment of the infrared optical system according to the present invention;

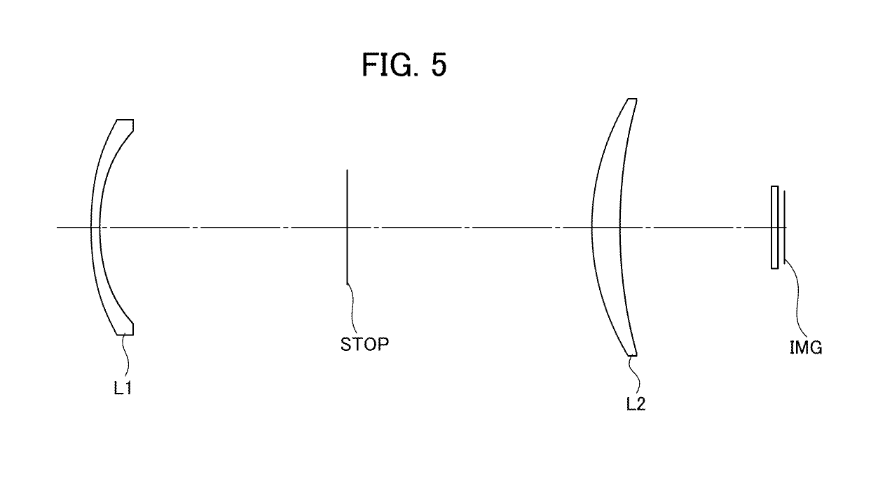

FIG. 6 depicts graphs of various aberrations developed in the third embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

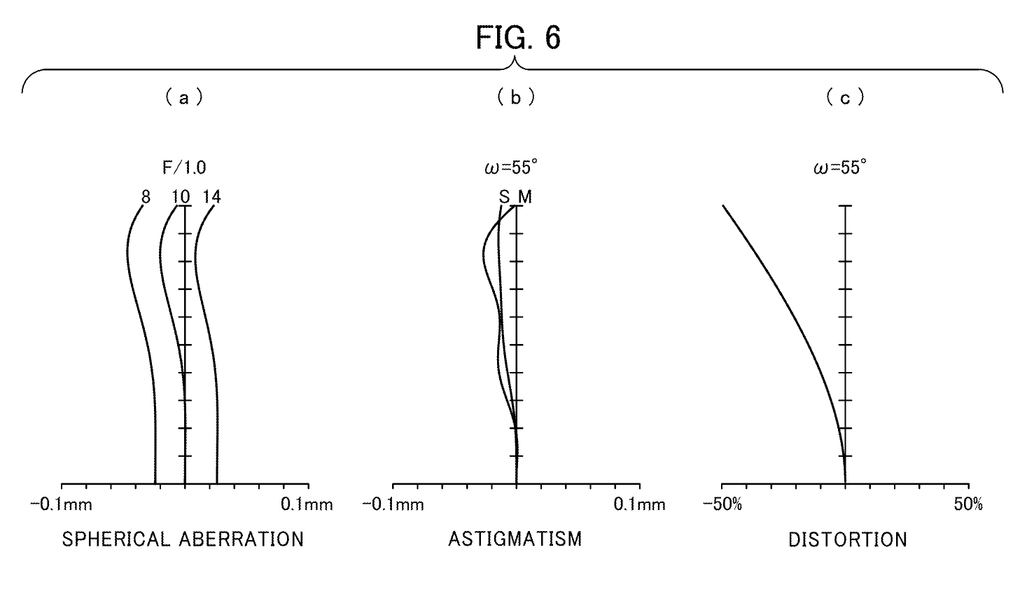

FIG. 7 is a vertical sectional view illustrating optics of a fourth embodiment of the infrared optical system according to the present invention;

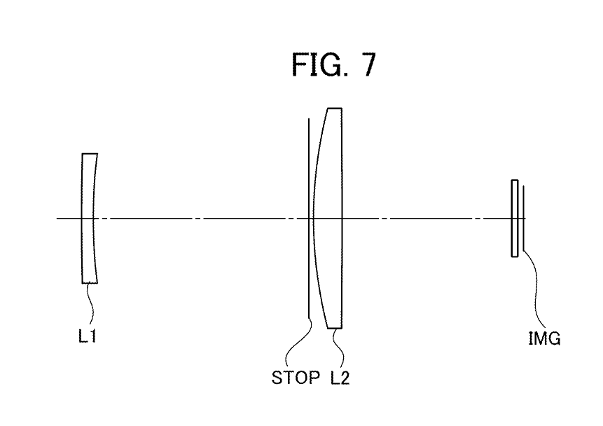

FIG. 8 depicts graphs of various aberrations developed in the fourth embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

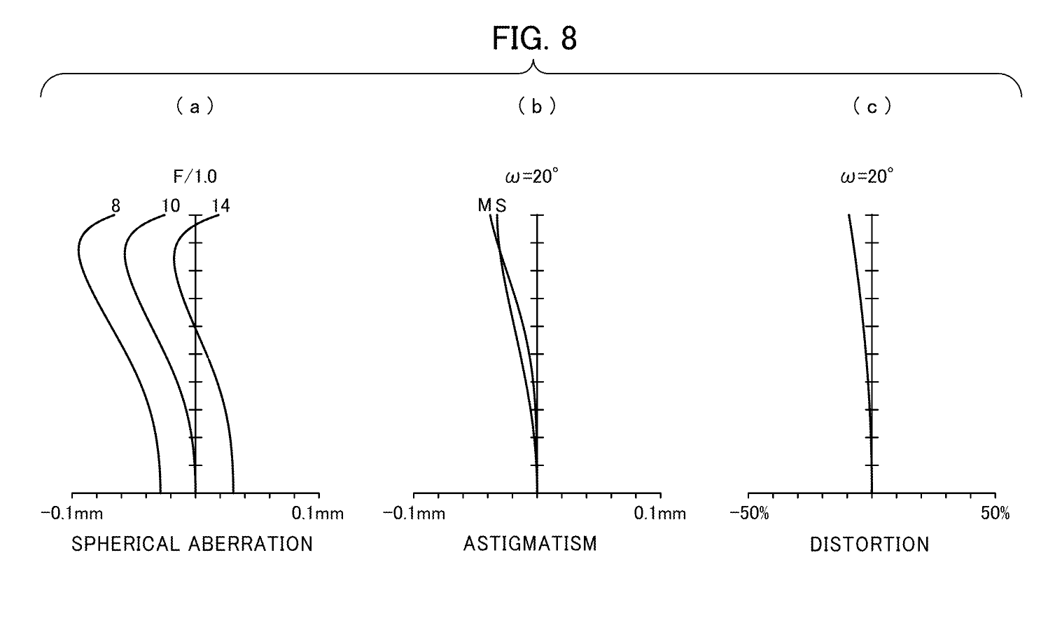

FIG. 9 is a vertical sectional view illustrating optics of a fifth embodiment of the infrared optical system according to the present invention;

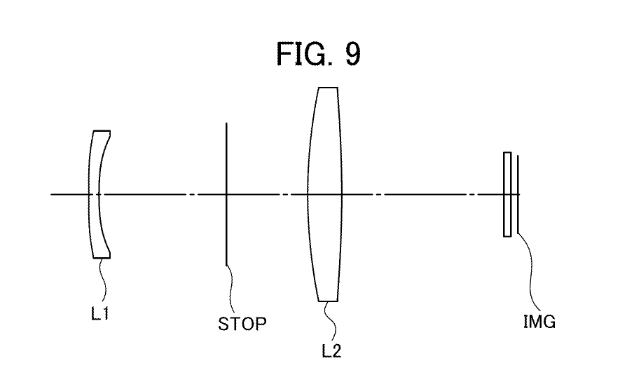

FIG. 10 depicts graphs of various aberrations developed in the fifth embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

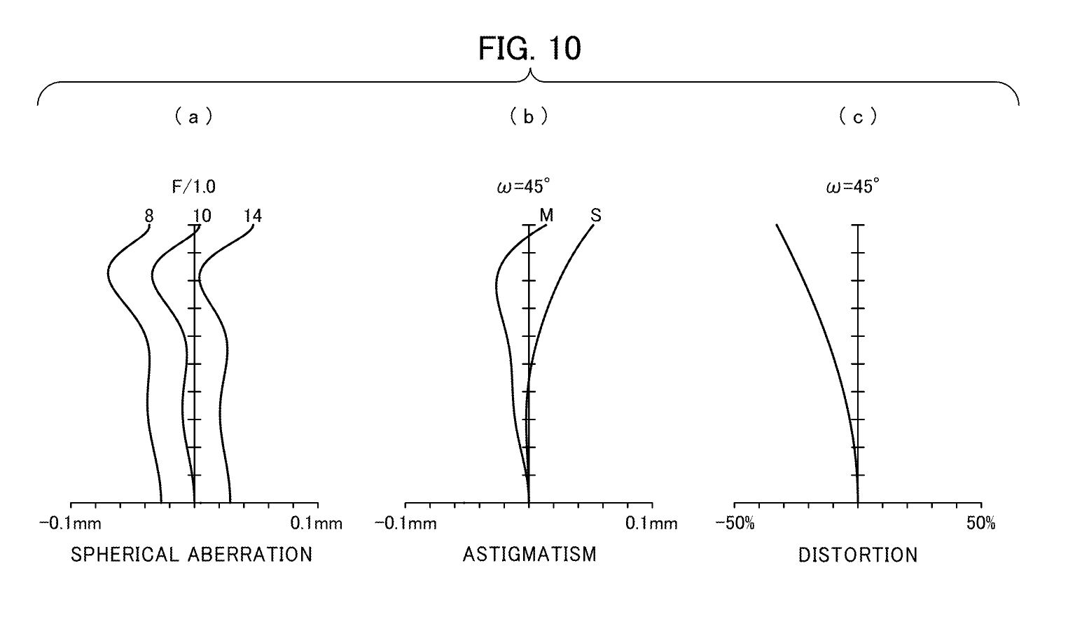

FIG. 11 is a vertical sectional view illustrating optics of a sixth embodiment of the infrared optical system according to the present invention;

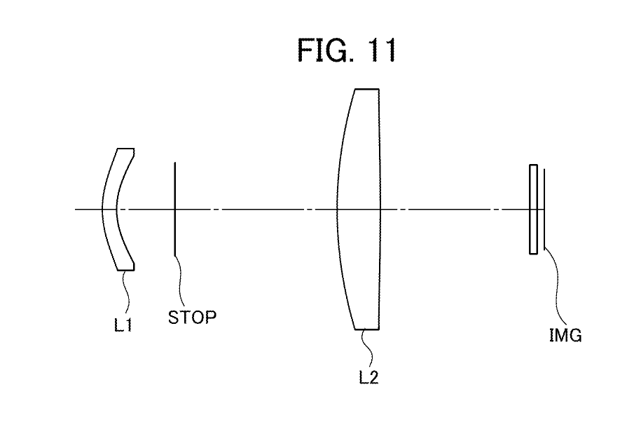

FIG. 12 depicts graphs of various aberrations developed in the sixth embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

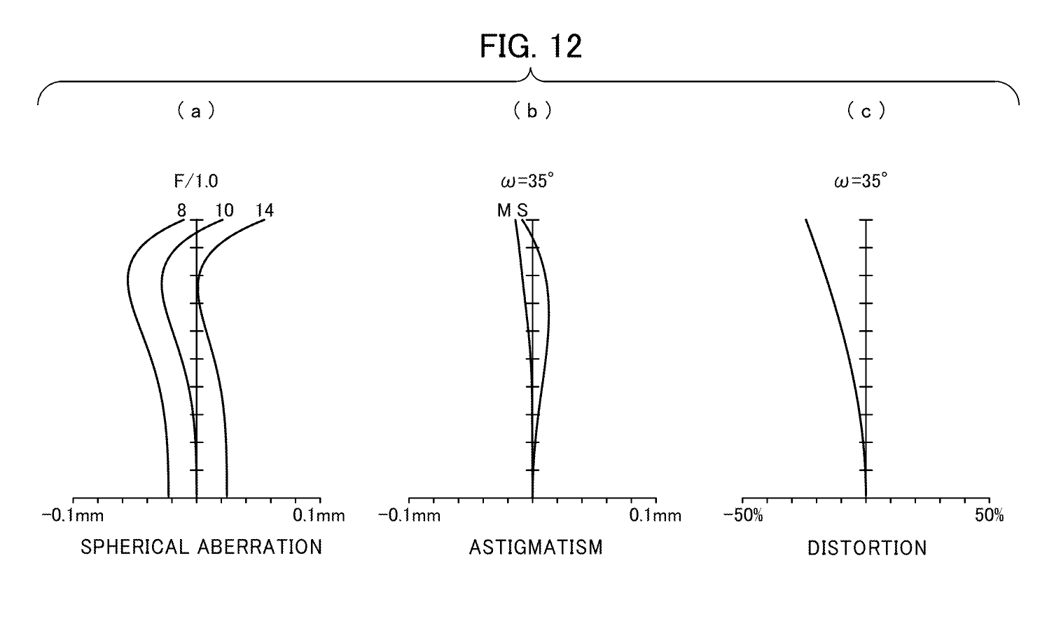

FIG. 13 is a vertical sectional view illustrating optics of a seventh embodiment of the infrared optical system according to the present invention;

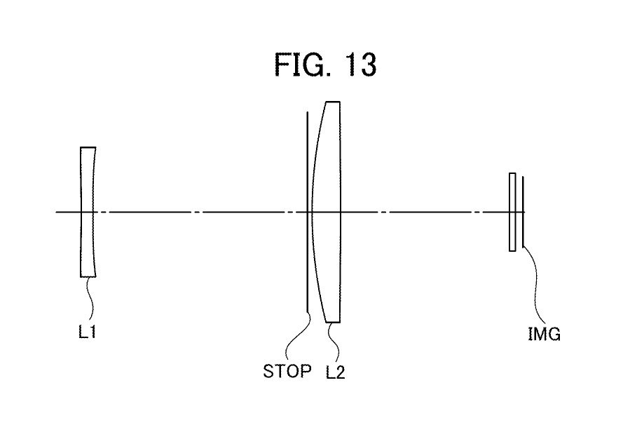

FIG. 14 depicts graphs of various aberrations developed in the seventh embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

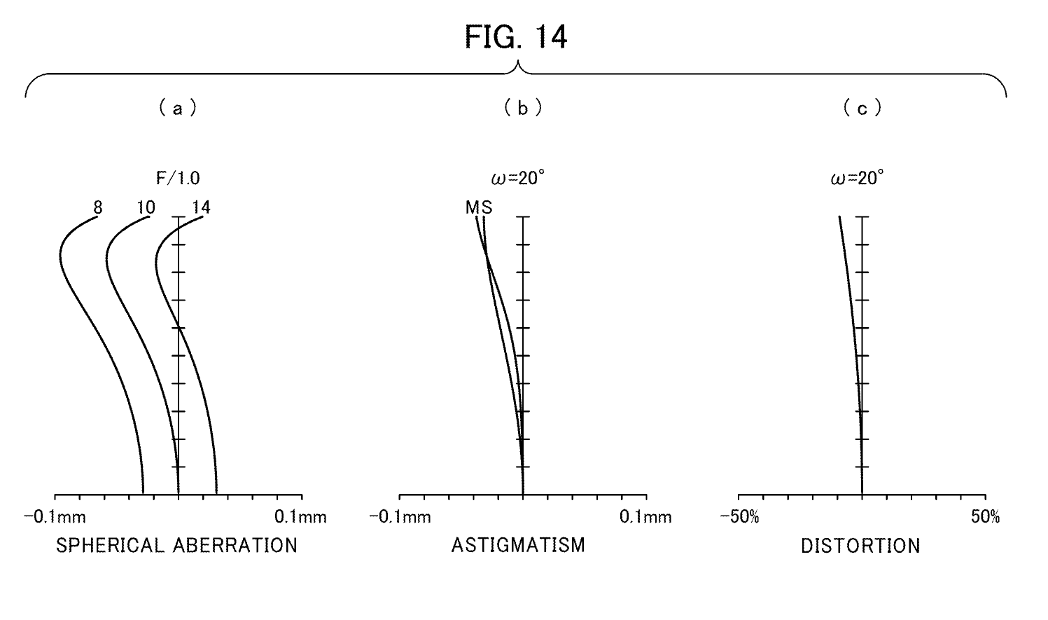

FIG. 15 is a vertical sectional view illustrating optics of an eighth embodiment of the infrared optical system according to the present invention;

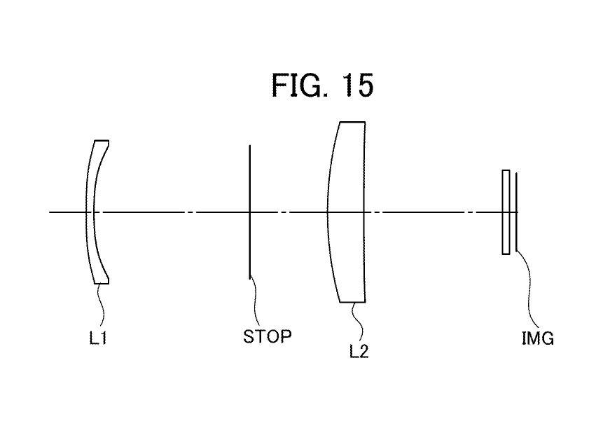

FIG. 16 depicts graphs of various aberrations developed in the eighth embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

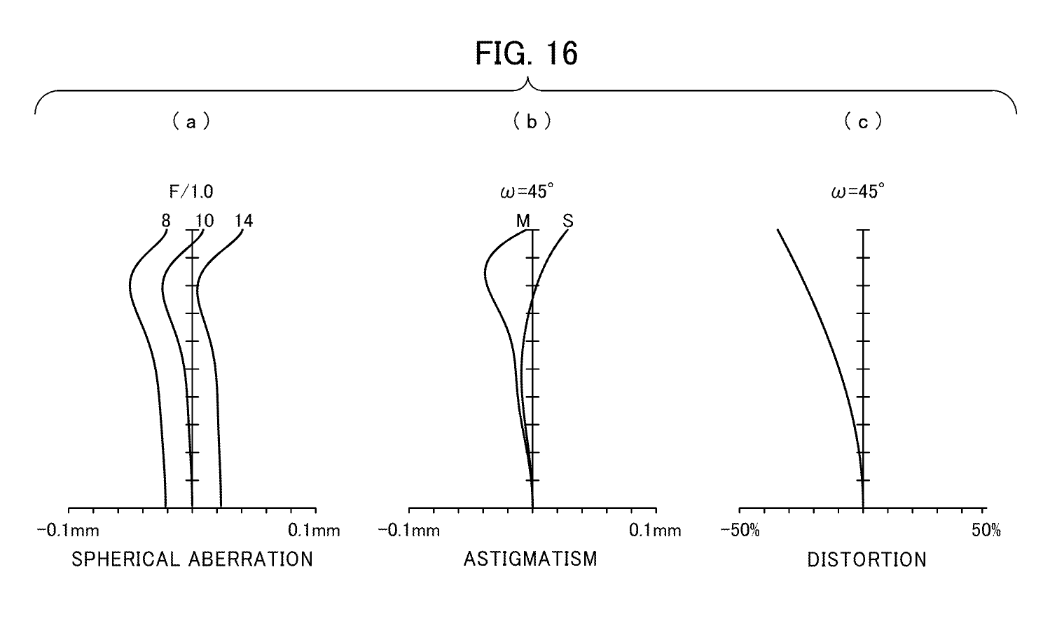

FIG. 17 is a vertical sectional view illustrating optics of a ninth embodiment of the infrared optical system according to the present invention;

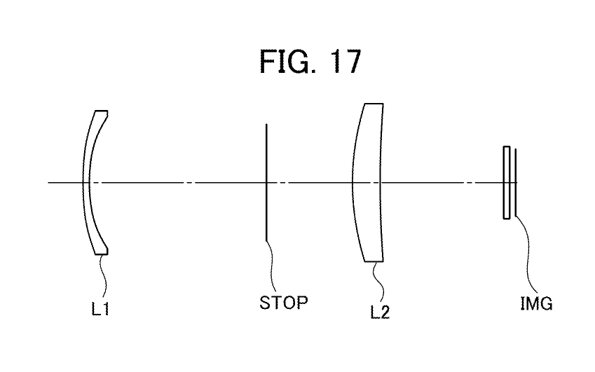

FIG. 18 depicts graphs of various aberrations developed in the ninth embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

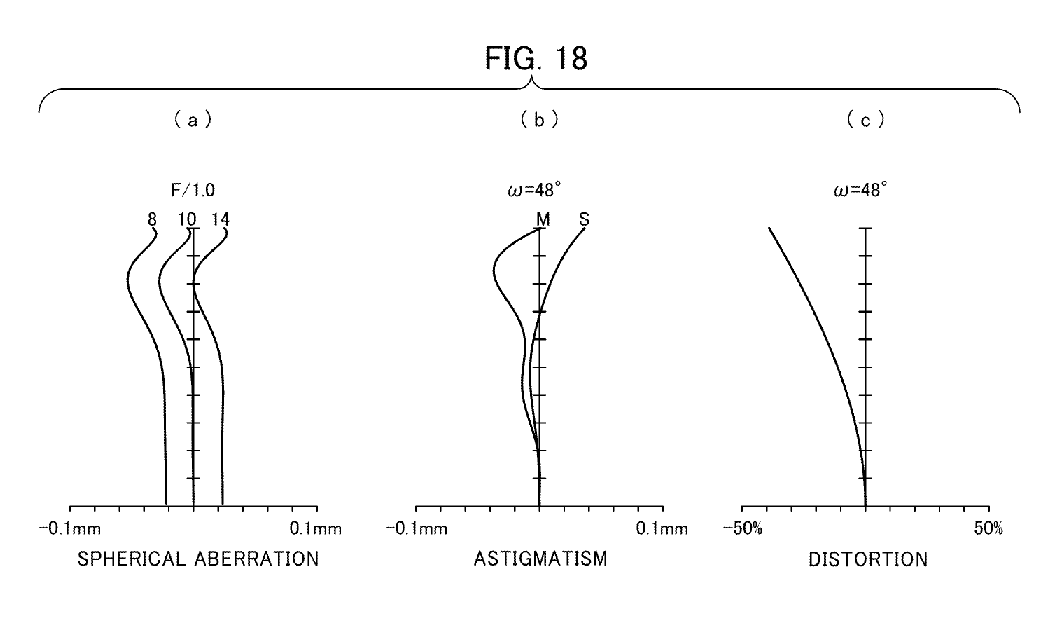

FIG. 19 is a vertical sectional view illustrating optics of a tenth embodiment of the infrared optical system according to the present invention;

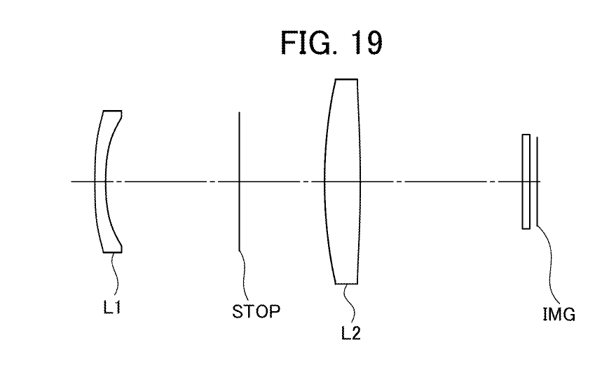

FIG. 20 depicts graphs of various aberrations developed in the tenth embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

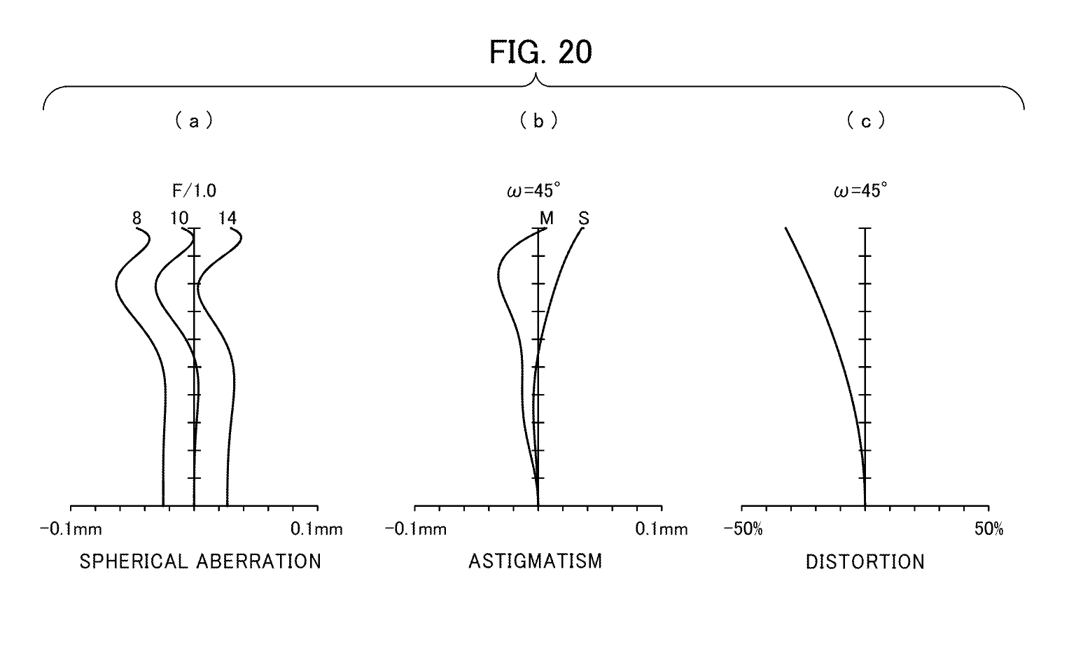

FIG. 21 is a vertical sectional view illustrating optics of an eleventh embodiment of the infrared optical system according to the present invention;

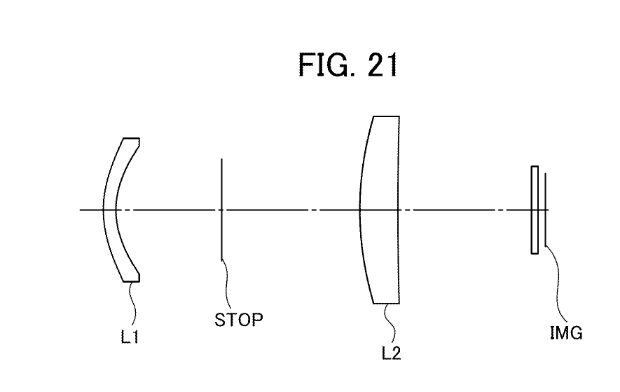

FIG. 22 depicts graphs of various aberrations developed in the eleventh embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction;

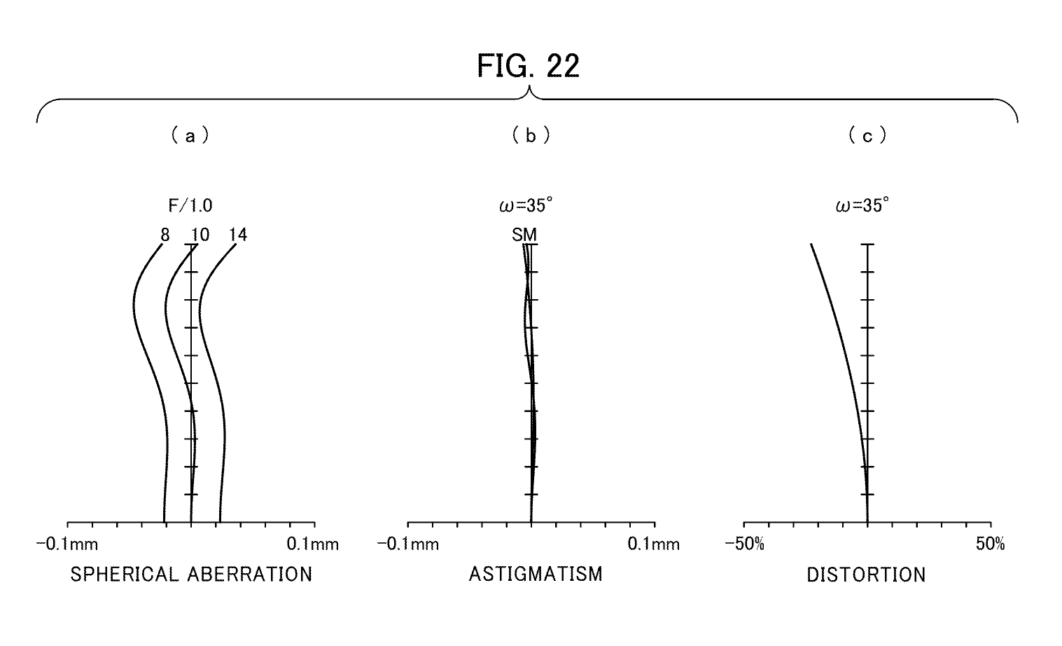

FIG. 23 is a vertical sectional view illustrating optics of a twelfth embodiment of the infrared optical system according to the present invention; and

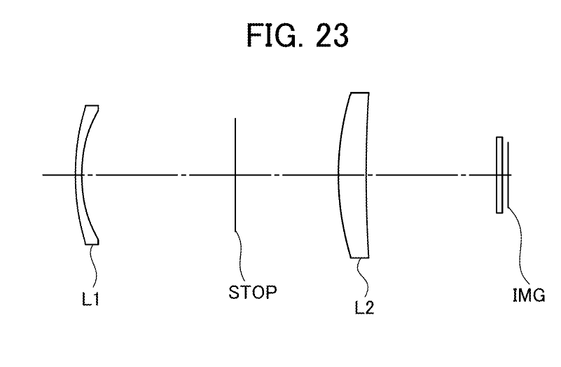

FIG. 24 depicts graphs of various aberrations developed in the twelfth embodiment of the infrared optical system according to the present invention, including graphs of (a) spherical aberration, (b) astigmatism, and (c) distortion aberration where the graph of spherical aberration (a) shows lines 8, 10, and 14 respectively charting spherical aberrations for wavelengths of 8 μm, 10 μm, and 14 μm while the graph of astigmatism (b) shows line S charting astigmatism for wavelength of 10 μm in the sagittal direction and line M charting astigmatism for wavelength of 10 μm in the meridional direction.

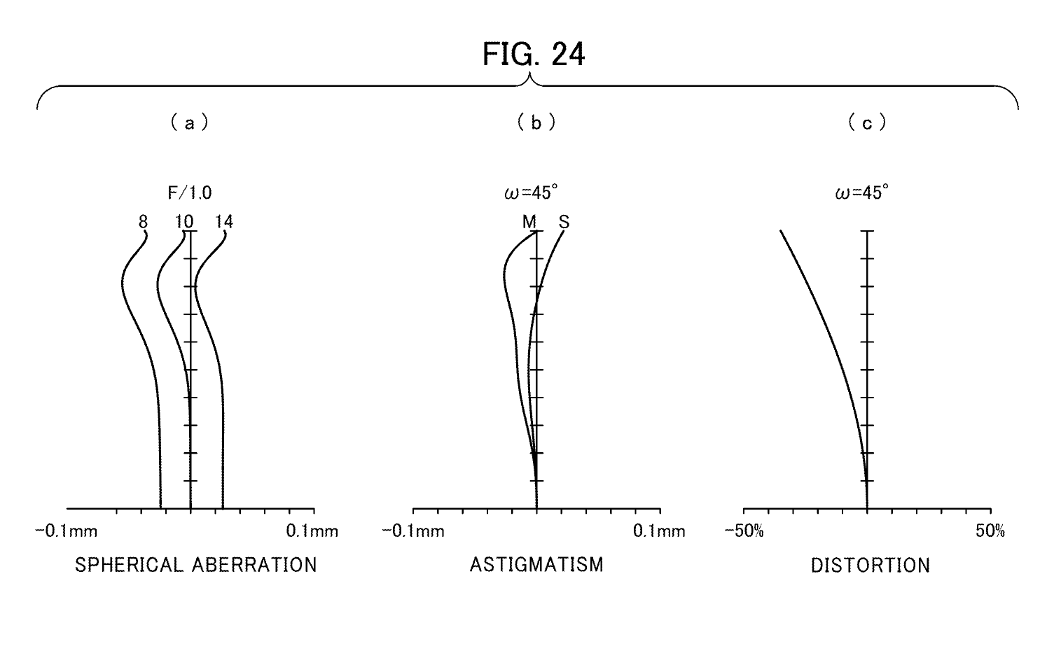

### DETAILED DESCRIPTION OF THE INVENTION

Lens data about each of the embodiments of the infrared optical system according to the present invention will be given below. Wavelength of our concern is 10 μm.

<Embodiment 1>

Focal Length f = 10.3 mm
F Number = 1.0
Angle of Field (2ω) = 70°

| Surface | Radius of | Distance | Lens | |
|---|---|---|---|---|
| Num | Curvature | btwn Surfaces | Material | Nd |
| *1 | 337.1818 | 2.17 | Ge | 4.0044 |
| *2 | 54.0041 | 20.41 | | 1.0000 |
| (Aperture Stop)3 | INF | 14.59 | | 1.0000 |
| *4 | 60.7849 | 4.27 | Ge | 4.0044 |
| *5 | −526.8440 | 24.71 | | 1.0000 |
| 6 | INF | 1.00 | Ge | 4.0044 |
| 7 | INF | 1.00 | | 1.0000 |

Coefficients of Aspherical Surfaces

| Surface | ε | A | B | C | D | E |
|---|---|---|---|---|---|---|
| 1 | 1.0000 | 0.00000E+000 | 4.06482E−005 | 8.21676E−009 | −8.37004E−010 | −3.62747E−012 |
| 2 | 13.2725 | 0.00000E+000 | 4.61480E−005 | 9.19327E−008 | −3.66826E−010 | −1.60024E−011 |
| 4 | 0.4302 | 0.00000E+000 | −7.08006E−007 | −1.19004E−009 | −4.24844E−012 | 8.30175E−014 |
| 5 | 1.0000 | 0.00000E+000 | 1.79662E−006 | −3.50169E−009 | 1.75841E−012 | 8.44718E−014 |

Values of the Terms in the Formulae

| | |
|---|---|
| Formula (1) | d/f = 3.41 |
| Formula (2) | f1/f2 = −1.18 |
| Formula (3) | r2/f = 5.27 |

<Embodiment 2>

Focal Length f = 11.5 mm
F Number = 1.0
Angle of Field (2ω) = 60°

| Surface | Radius of | Distance | Lens | |
|---|---|---|---|---|
| Num | Curvature | btwn Surfaces | Material | Nd |
| *1 | −2010.8899 | 2.34 | Ge | 4.0044 |
| *2 | 75.3424 | 21.46 | | 1.0000 |
| (Aperture Stop)3 | INF | 14.38 | | 1.0000 |
| *4 | 70.4046 | 4.90 | Ge | 4.0044 |
| *5 | −323.1153 | 26.40 | | 1.0000 |
| 6 | INF | 1.00 | Ge | 4.0044 |
| 7 | INF | 1.00 | | 1.0000 |

Coefficients of Aspherical Surfaces

| Surface | ε | A | B | C | D | E |
|---|---|---|---|---|---|---|
| 1 | 1.0000 | 0.00000E+000 | 7.17980E−005 | −2.99560E−007 | 8.89654E−010 | −4.74321E−012 |
| 2 | 1.0000 | 0.00000E+000 | 8.60264E−005 | −1.86590E−007 | 6.75849E−010 | −9.03629E−012 |
| 4 | 0.9309 | 0.00000E+000 | −6.58696E−007 | −8.42890E−010 | −1.26210E−011 | 6.24055E−014 |
| 5 | 1.0000 | 0.00000E+000 | 1.64741E−006 | −2.93559E−009 | −7.59822E−012 | 6.17267E−014 |

Values of the Terms in the Formulae

| | |
|---|---|
| Formula (1) | d/f = 3.12 |
| Formula (2) | f1/f2 = −1.24 |
| Formula (3) | r2/f = 6.55 |

<Embodiment 3>

Focal Length f = 7.6 mm
F Number = 1.0
Angle of Field (2ω) = 110°

| Surface | Radius of | Distance | Lens | |
|---|---|---|---|---|
| Num | Curvature | btwn Surfaces | Material | Nd |
| *1 | 47.9663 | 1.34 | Ge | 4.0044 |
| *2 | 30.6174 | 38.31 | | 1.0000 |
| (Aperture Stop)3 | INF | 37.88 | | 1.0000 |
| *4 | 36.0899 | 4.35 | Ge | 4.0044 |
| *5 | 75.6184 | 23.46 | | 1.0000 |
| 6 | INF | 1.00 | Ge | 4.0044 |
| 7 | INF | 1.00 | | |

Coefficients of Aspherical Surfaces

| Surface | ε | A | B | C | D | E |
|---|---|---|---|---|---|---|
| 1 | 1.0000 | 0.00000E+000 | 1.87737E−005 | 1.66360E−008 | −1.02334E−010 | −2.69329E−014 |
| 2 | 1.0000 | 0.00000E+000 | 2.51546E−005 | 3.54785E−008 | 9.94135E−011 | −7.24854E−013 |
| 4 | 1.0000 | 0.00000E+000 | −1.75435E−006 | 4.38951E−009 | −6.35292E-012 | −3.30332E−015 |
| 5 | 1.0000 | 0.00000E+000 | −3.34829E−007 | 8.03368E−009 | −1.75290E−011 | 8.75427E−015 |

Values of the Terms in the Formulae

| | |
|---|---|
| Formula (1) | d/f = 10.00 |
| Formula (2) | f1/f2 = −1.41 |
| Formula (3) | r2/f = 4.02 |

<Embodiment 4>

Focal Length f = 16.7 mm
F Number = 1.0
Angle of Field (2ω) = 40°

| Surface | Radius of | Distance | Lens | |
|---|---|---|---|---|
| Num | Curvature | btwn Surfaces | Material | Nd |
| *1 | 1486.3642 | 2.00 | Ge | 4.0044 |
| *2 | 117.5351 | 36.79 | | 1.0000 |
| (Aperture Stop)3 | INF | 0.80 | | 1.0000 |
| *4 | 71.6121 | 4.88 | Ge | 4.0044 |
| *5 | −1195.4868 | 28.98 | | 1.0000 |
| 6 | INF | 1.00 | Ge | 4.0044 |
| 7 | INF | 1.00 | | |

Coefficients of Aspherical Surfaces

| Surface | ε | A | B | C | D | E |
|---|---|---|---|---|---|---|
| 1 | 1.0000 | 0.00000E+000 | 1.01116E−005 | −1.70005E−008 | −1.54714E−010 | 1.34054E−013 |
| 2 | 1.0000 | 0.00000E+000 | 1.49933E−005 | −8.97612E−009 | −1.71167E−010 | 8.15588E−014 |
| 4 | −0.1005 | 0.00000E+000 | −2.78230E−007 | 9.24795E−011 | −3.06952E−012 | 9.17633E−015 |
| 5 | 1.0000 | 0.00000E+000 | 6.47781E−007 | −4.85740E−010 | −1.90099E−012 | 8.73265E−015 |

Values of the Terms in the Formulae

| | |
|---|---|
| Formula (1) | d/f = 2.26 |
| Formula (2) | f1/f2 = −1.89 |
| Formula (3) | r2/f = 7.06 |

<Embodiment 5>

Focal Length f = 8.2 mm
F Number = 1.0
Angle of Field (2ω) = 90°

| Surface | Radius of | Distance | Lens | |
|---|---|---|---|---|
| Num | Curvature | btwn Surfaces | Material | Nd |
| *1 | −2298.4854 | 1.47 | Ge | 4.0044 |
| *2 | 44.2970 | 18.38 | | 1.0000 |
| (Aperture Stop)3 | INF | 11.71 | | 1.0000 |
| *4 | 70.8007 | 4.92 | Ge | 4.0044 |
| *5 | −149.3585 | 23.38 | | 1.0000 |
| 6 | INF | 1.00 | Ge | 4.0044 |
| 7 | INF | 1.00 | | 1.0000 |

Coefficients of Aspherical Surfaces

| Surface | ε | A | B | C | D | E |
|---|---|---|---|---|---|---|
| 1 | 1.0000 | 0.00000E+000 | 2.08127E−004 | −1.34785E−006 | 1.21830E−009 | −1.18628E−012 |
| 2 | 1.0000 | 0.00000E+000 | 2.42061E−004 | −4.53259E−007 | −8.59963E−009 | 1.33456E−011 |
| 4 | 1.0000 | 0.00000E+000 | 1.61987E−006 | −4.60274E−008 | 2.18211E−010 | −2.97119E−013 |
| 5 | 1.0000 | 0.00000E+000 | 6.01072E−006 | −5.48252E−008 | 2.58804E−010 | −3.69564E−013 |

Values of the Terms in the Formulae

| | |
|---|---|
| Formula (1) | d/f = 3.67 |
| Formula (2) | f1/f2 = −0.89 |
| Formula (3) | r2/f = 5.41 |

<Embodiment 6>

Focal Length f = 10.4 mm
F Number = 1.0
Angle of Field (2ω) = 70°

| Surface | Radius | Distance | Lens | |
|---|---|---|---|---|
| Num | of Curvature | btwn Surfaces | Material | Nd |
| *1 | 12.6540 | 1.96 | Ge | 4.0044 |
| *2 | 9.4345 | 8.02 | | 1.0000 |
| (Aperture Stop)3 | INF | 22.26 | | 1.0000 |
| *4 | 54.7505 | 5.94 | Ge | 4.0044 |
| *5 | −335.1926 | 20.53 | | 1.0000 |
| 6 | INF | 1.00 | Ge | 4.0044 |
| 7 | INF | 1.00 | | |

Coefficients of Aspherical Surfaces

| Surface | ε | A | B | C | D | E |
|---|---|---|---|---|---|---|
| 1 | 1.0000 | 0.00000E+000 | −1.77800E−004 | −1.35986E−006 | 1.74560E−008 | −8.29206E−011 |
| 2 | 1.0000 | 0.00000E+000 | −3.07086E−004 | −3.27064E−006 | 5.83959E−008 | −5.41319E−010 |
| 4 | 1.0000 | 0.00000E+000 | −1.62690E−006 | 2.24846E−009 | 8.17462E−014 | −4.67630E−015 |
| 5 | 1.0000 | 0.00000E+000 | 2.47744E−006 | 1.30831E−009 | −1.37111E−012 | −3.51700E−015 |

Values of the Terms in the Formulae

| | |
|---|---|
| Formula (1) | d/f = 2.92 |
| Formula (2) | f1/f2 = −1.44 |
| Formula (3) | r2/f = 0.91 |

<Embodiment 7>

Focal Length f = 16.6 mm
F Number = 1.0
Angle of Field (2ω) = 40°

| Surface | Radius | Distance | Lens | |
|---|---|---|---|---|
| Num | of Curvature | btwn Surfaces | Material | Nd |
| *1 | −150.3697 | 1.99 | Ge | 4.0044 |
| *2 | 831.6981 | 36.68 | | 1.0000 |
| (Aperture Stop)3 | INF | 0.79 | | 1.0000 |
| *4 | 73.2206 | 4.87 | Ge | 4.0044 |
| *5 | −920.8177 | 28.90 | | 1.0000 |
| 6 | INF | 1.00 | Ge | 4.0044 |
| 7 | INF | 1.29 | | |

Coefficients of Aspherical Surfaces

| Surface | ε | A | B | C | D | E |
|---|---|---|---|---|---|---|
| 1 | 1.0000 | 0.00000E+000 | 2.97092E−005 | −6.59391E−008 | −1.64006E−010 | 5.60486E−013 |
| 2 | 1.0000 | 0.00000E+000 | 3.38288E−005 | −4.59588E−008 | −2.39486E−010 | 6.68353E−013 |
| 4 | −0.1005 | 0.00000E+000 | −2.69826E−007 | −6.94847E−010 | 6.82272E−013 | 2.25602E−015 |
| 5 | 1.0000 | 0.00000E+000 | 6.54883E−007 | −1.27891E−009 | 2.05145E−012 | 1.14771E−015 |

Values of the Terms in the Formulae

| | |
|---|---|
| Formula (1) | d/f = 2.25 |
| Formula (2) | f1/f2 = −1.87 |
| Formula (3) | r2/f = 50.00 |

<Embodiment 8>

Focal Length f = 8.4 mm
F Number = 1.0
Angle of Field (2ω) = 90°

| Surface | Radius of | Distance | Lens | |
|---|---|---|---|---|
| Num | Curvature | btwn Surfaces | Material | Nd |
| *1 | 162.4908 | 1.11 | Ge | 4.0044 |
| *2 | 43.4520 | 22.47 | | 1.0000 |
| (Aperture Stop)3 | INF | 11.18 | | 1.0000 |
| *4 | 46.2384 | 5.23 | Ge | 4.0044 |
| *5 | 1416.8967 | 19.97 | | 1.0000 |
| 6 | INF | 1.00 | Ge | 4.0044 |
| 7 | INF | | | 1.0000 |

Coefficients of Aspherical Surfaces

| Surface | ε | A | B | C | D | E |
|---|---|---|---|---|---|---|
| 1 | 1.0000 | 0.00000E+000 | 1.76405E−004 | −1.01441E−006 | 3.24594E−009 | −1.84502E−011 |
| 2 | 1.0000 | 0.00000E+000 | 2.02364E−004 | −6.18613E−007 | 1.99954E−009 | −3.86993E−011 |
| 4 | 1.0000 | 0.00000E+000 | 5.31536E−007 | −2.71215E−008 | 1.80955E−010 | −1.91888E−013 |
| 5 | 1.0000 | 0.00000E+000 | 5.56952E−006 | −4.34697E−008 | 3.06620E−010 | −4.54106E−013 |

Values of the Terms in the Formulae

| | |
|---|---|
| Formula (1) | d/f = 4.00 |
| Formula (2) | f1/f2 = −1.25 |
| Formula (3) | r2/f = 5.17 |

<Embodiment 9>

Focal Length f = 8.1 mm (λ = 10 μm)
F Number = 1.0
Angle of Field (2ω) = 96°

| Surface | Radius of | Distance | Lens | |
|---|---|---|---|---|
| Num | Curvature | btwn Surfaces | Material | Nd |
| *1 | 52.0447 | 1.06 | Ge | 4.0044 |
| *2 | 29.2108 | 29.74 | | 1.0000 |
| (Aperture Stop)3 | INF | 14.43 | | 1.0000 |
| *4 | 40.7591 | 4.65 | Ge | 4.0044 |
| *5 | 171.1160 | 20.74 | | 1.0000 |
| 6 | INF | 1.00 | Ge | 4.0044 |
| 7 | INF | 1.00 | | 1.0000 |

Coefficients of Aspherical Surfaces

| Surface | ε | A | B | C | D | E |
|---|---|---|---|---|---|---|
| 1 | 1.0000 | 0.00000E+000 | 5.78551E−005 | −8.53576E−008 | −5.01290E−011 | −3.67753E−012 |
| 2 | 1.0000 | 0.00000E+000 | 7.36817E−005 | −5.20797E−009 | 1.33021E−009 | −1.63103E−011 |
| 4 | 1.0000 | 0.00000E+000 | −8.51070E−007 | −2.13180E−008 | 1.06362E−010 | −2.92503E−013 |
| 5 | 1.0000 | 0.00000E+000 | 2.69204E−006 | −3.26778E−008 | 1.79624E−010 | −4.83725E−013 |

Values of the Terms in the Formulae

| | |
|---|---|
| Formula (1) | d/f = 5.44 |
| Formula (2) | f1/f2 = −1.32 |
| Formula (3) | r2/f = 3.60 |

<Embodiment 10>

Focal Length f = 8.4 mm (λ = 10 μm)
F Number = 1.0
Angle of Field (2ω) = 90°

| Surface | Radius of | Distance | Lens | |
|---|---|---|---|---|
| Num | Curvature | btwn Surfaces | Material | Nd |
| *1 | 138.4200 | 1.46 | Ge | 4.0044 |
| *2 | 33.9541 | 18.17 | | 1.0000 |
| (Aperture Stop)3 | INF | 11.58 | | 1.0000 |
| *4 | 64.8832 | 4.86 | Ge | 4.0044 |
| *5 | −164.2972 | 22.02 | | 1.0000 |
| 6 | INF | 1.00 | Ge | 4.0044 |
| 7 | INF | 1.00 | | 1.0000 |

Coefficients of Aspherical Surfaces

| Surface | ε | A | B | C | D | E |
|---|---|---|---|---|---|---|
| 1 | 1.0000 | 0.00000E+000 | 1.88517E−004 | −8.44557E−007 | −6.67904E−010 | −1.03254E−011 |
| 2 | 1.0000 | 0.00000E+000 | 2.27891E−004 | 1.18665E−008 | −4.43672E−009 | −6.61074E−011 |
| 4 | −0.1005 | 0.00000E+000 | 1.23922E−006 | −4.02577E−008 | 2.54964E−010 | −2.80349E−013 |
| 5 | 1.0000 | 0.00000E+000 | 6.26082E−006 | −5.31975E−008 | 3.29460E−010 | −4.08537E−013 |

Values of the Terms in the Formulae

| | |
|---|---|
| Formula (1) | d/f = 3.67 |
| Formula (2) | f1/f2 = −0.96 |
| Formula (3) | r2/f = 4.19 |

<Embodiment 11>

Focal Length f = 10.2 mm (λ = 10 μm)
F Number = 1.0
Angle of Field (2ω) = 70°

| Surface | Radius of | Distance | Lens | |
|---|---|---|---|---|
| Num | Curvature | btwn Surfaces | Material | Nd |
| *1 | 16.5671 | 1.92 | Ge | 4.0044 |
| *2 | 12.5558 | 16.15 | | 1.0000 |
| (Aperture Stop)3 | INF | 21.08 | | 1.0000 |
| *4 | 47.7710 | 5.82 | Ge | 4.0044 |
| *5 | 723.4824 | 20.50 | | 1.0000 |
| 6 | INF | 1.00 | Ge | 4.0044 |
| 7 | INF | 1.00 | | 1.0000 |

Coefficients of Aspherical Surfaces

| Surface | ε | A | B | C | D | E |
|---|---|---|---|---|---|---|
| 1 | 1.0000 | 0.00000E+000 | −4.22239E−005 | −9.59012E−007 | 1.17684E−008 | −5.05490E−011 |
| 2 | 1.0000 | 0.00000E+000 | −5.74346E−005 | −2.04963E−006 | 3.12237E−008 | −1.78038E−010 |
| 4 | 1.0000 | 0.00000E+000 | −2.42970E−006 | 1.35178E−008 | −6.69483E−011 | 7.17135E-014 |
| 5 | 1.0000 | 0.00000E+000 | 7.54192E−007 | 1.76076E−008 | −1.05060E−010 | 1.46793E-013 |

Values of the Terms in the Formulae

| | |
|---|---|
| Formula (1) | d/f = 3.66 |
| Formula (2) | f1/f2 = −1.59 |
| Formula (3) | r2/f = 1.23 |

<Embodiment 12>

Focal Length f = 8.5 mm (λ = 10 μm)
F Number = 1.0
Angle of Field (2ω) = 90°

| Surface | Radius of | Distance | Lens | |
|---|---|---|---|---|
| Num | Curvature | btwn Surfaces | Material | Nd |
| *1 | 44.8927 | 1.11 | Ge | 4.0044 |
| *2 | 26.2305 | 26.66 | | 1.0000 |
| (Aperture Stop)3 | INF | 17.88 | | 1.0000 |
| *4 | 45.3080 | 4.83 | Ge | 4.0044 |
| *5 | 236.8980 | 22.63 | | 1.0000 |
| 6 | INF | 1.00 | Ge | 4.0044 |
| 7 | INF | 1.00 | | 1.0000 |

Coefficients of Aspherical Surfaces

| Surface | E | A | B | C | D | E |
|---|---|---|---|---|---|---|
| 1 | 1.0000 | 0.00000E+000 | 1.28452E−005 | 1.47431E−007 | −9.86571E−010 | −1.94212E−012 |
| 2 | 1.0000 | 0.00000E+000 | 2.37849E−005 | 2.20580E−007 | −7.87749E−011 | −1.18649E−011 |
| 4 | 1.0000 | 0.00000E+000 | −1.50872E−006 | −5.19557E−009 | 2.93309E−011 | −1.04649E−013 |
| 5 | 1.0000 | 0.00000E+000 | 1.28141E−006 | −8.12332E−009 | 4.31903E−011 | −1.43361E−013 |

Values of the Terms in the Formulae

| | |
|---|---|
| Formula (1) | d/f = 5.26 |
| Formula (2) | f1/f2 = −1.20 |
| Formula (3) | r2/f = 3.10 |

### DESCRIPTION OF REFERENCE NUMERALS

STOP Aperture Stop
IMG Image
L1 Front or First Lens
L2 Rear or Second Lens

1. An infrared optical system of two-lens structure, comprising a front or first lens of negative refractive power and a rear or second lens of positive refractive power disposed in series relative to an object,
the first lens having its concave surface faced toward the imaging plane,
the second lens having its convex surface faced toward the object,
the infrared optical system meeting the requirements as defined in the following formula (1):
2.1≦d/f≦11 (1)
where d is an axial distance from the surface of the first lens closer to the imaging plane to the surface of the second lens closer to the object, and f is a focal length of the entire optical system.

2. The infrared optical system according to claim 1, wherein an aperture stop is disposed between the first and second lenses.

3. The infrared optical system according to claim 1, wherein the infrared optical system meets the requirements as defined in the following formula (2):
−2.1≦f1/f2≦−0.80 (2)
where f1 is a focal length of the first lens, and f2 is a focal length of the second lens.

4. The infrared optical system according to claim 1, wherein the first and second lenses made of germanium.

5. The infrared optical system according to claim 1, wherein the infrared optical system meets the requirements as defined in the following formula (3):
0.8≦r2/f≦60 (3)
where r2 is a radius of curvature in the surface of the first lens closer to the imaging plane, and f is a focal length of the entire optical system.

6. The infrared optical system according to claim 2, wherein the infrared optical system meets the requirements as defined in the following formula (2):
−2.1≦f1/f2≦−0.80 (2)
where f1 is a focal length of the first lens, and f2 is a focal length of the second lens.

7. The infrared optical system according to claim 2, wherein the first and second lenses made of germanium.

8. The infrared optical system according to claim 3, wherein the first and second lenses made of germanium.

9. The infrared optical system according to claim 2, wherein the infrared optical system meets the requirements as defined in the following formula (3):
0.8≦r2/f≦60 (3)
where r2 is a radius of curvature in the surface of the first lens closer to the imaging plane, and f is a focal length of the entire optical system.

10. The infrared optical system according to claim 3, wherein the infrared optical system meets the requirements as defined in the following formula (3):
0.8≦r2/f≦60 (3)
where r2 is a radius of curvature in the surface of the first lens closer to the imaging plane, and f is a focal length of the entire optical system.

11. The infrared optical system according to claim 4, wherein the infrared optical system meets the requirements as defined in the following formula (3):
0.8≦r2/f≦60 (3)
where r2 is a radius of curvature in the surface of the first lens closer to the imaging plane, and f is a focal length of the entire optical system.
